(19) United States
(12) Patent Application Publication
(10) Pub. No.: US 2018/0109423 A1
(43) Pub. Date: Apr. 19, 2018

(54) ENHANCED AND CONCURRENT ASYMMETRIC TOPOLOGY RECONCILIATION IN A COMPUTER CLUSTER

(71) Applicant: International Business Machines Corporation, Armonk, NY (US)

(72) Inventors: Esdras E. Cruz-Aguilar, Round Rock, TX (US); Perinkulam I. Ganesh, Round Rock, TX (US)

(21) Appl. No.: 15/292,322

(22) Filed: Oct. 13, 2016

(51) Int. Cl. H04L 12/24

(52) U.S. Cl. CPC H04L 41/12; H04L 41/0813

(57) ABSTRACT

A method includes a processor determining a number of nodes other than the particular node from among the plurality of nodes that the particular node can communicate with at a particular point in time; determining that a number of the nodes within the plurality of nodes that the particular node can communicate with at a particular point in time is less than a value of a variable; storing in a candidate array the determined number of nodes within the plurality of nodes that the particular node can communicate with at a particular point in time which is less than the value of a variable, wherein the candidate array identifies those nodes within the plurality of nodes that can be taken to a DOWN state; and determining at least one of the nodes stored in the candidate array to be taken to a DOWN state.

### BACKGROUND

The present invention relates to multiple computers connected together in a cluster configuration, and more specifically, to a method, system and computer program product that reconciles an asymmetric topology condition in a cluster of computers.

In the field of computer processing, it is known to connect together a plurality of computers in a cluster having a certain configuration or topology. Each computer within a cluster is typically referred to as a node. This cluster configuration is utilized in part to divide software processing tasks among the computers in the cluster, which leads to improvements in efficiency in completing the oftentimes complex software processing tasks.

A common cluster configuration or topology is a symmetric one in which the various nodes are all connected to each other and to other devices such as, for example, a data storage device or repository. In addition, for redundancy purposes, the nodes may be connected together using more than one connection scheme, including using different types of wired or wireless mediums or protocols such as, for example, Ethernet, TCP/IP, TCP, a storage area network (SAN), a local area network (LAN), a wide area network (WAN), a data information service center (DISK.), or a direct connection.

Nodes within a cluster commonly use “heartbeats” to communicate with each other on a regular basis (e.g., twice per second). This allows the node sending the heartbeat signal to determine if one or more receiving nodes, including the communication interfaces of the nodes and the communication medium(s) or protocol(s) between the nodes, are functioning properly. Often, a “gossip” heartbeat may be communicated which includes not only information about the sending or transmitting node (e.g., that it is active), but also includes information that the sending node has received from other nodes indicating, for example, which of the other nodes are available and the topology sensed by each of the other nodes, i.e., which of the other nodes each other node thinks are available.

Although transmitting heartbeats over multiple interfaces may improve reliability, a partial loss of connectivity between one or more nodes to other nodes within the cluster may cause asymmetric topological views among the nodes, i.e., different nodes may have different views of which other nodes are connected and functioning. Asymmetric topologies may lead to cluster inoperability issues. For example, cluster-wide locks and node leadership may be erroneously granted, thereby leading to repository corruption and confusion among upper network layers.

### SUMMARY

According to one or more embodiments of the present invention, a computer-implemented method includes determining, by a processor located within a particular node among a plurality of nodes, a number of nodes other than the particular node from among the plurality of nodes that the particular node can communicate with at a particular point in time; and determining, by the processor located within the particular node, that a number of the nodes within the plurality of nodes that the particular node can communicate with at a particular point in time is less than a value of a variable. The method also includes storing, by the processor located within the particular node, in a candidate array the determined number of nodes within the plurality of nodes that the particular node can communicate with at a particular point in time which is less than the value of a variable, wherein the candidate array identifies those nodes within the plurality of nodes that can be taken to a DOWN state in which the identified nodes cannot communicate with any others of the plurality of nodes; and determining, by the processor located within the particular array, at least one of the nodes stored in the candidate array to be taken to a DOWN state.

According to another embodiment of the present invention, a system includes a processor in communication with one or more types of memory, the processor configured to determine a number of nodes other than the particular node from among the plurality of nodes that the particular node can communicate with at a particular point in time; and to determine that a number of the nodes within the plurality of nodes that the particular node can communicate with at a particular point in time is less than a value of a variable. The processor is also configured to store in a candidate array the determined number of nodes within the plurality of nodes that the particular node can communicate with at a particular point in time which is less than the value of a variable, wherein the candidate array identifies those nodes within the plurality of nodes that can be taken to a DOWN state in which the identified nodes cannot communicate with any others of the plurality of nodes; and to determine at least one of the nodes stored in the candidate array to be taken to a DOWN state.

According to yet another embodiment of the present invention, a computer program product includes a non-transitory storage medium readable by a processing circuit and storing instructions for execution by the processing circuit for performing a method that includes determining a number of nodes other than the particular node from among the plurality of nodes that the particular node can communicate with at a particular point in time; and determining that a number of the nodes within the plurality of nodes that the particular node can communicate with at a particular point in time is less than a value of a variable. The method also includes storing in a candidate array the determined number of nodes within the plurality of nodes that the particular node can communicate with at a particular point in time which is less than the value of a variable, wherein the candidate array identifies those nodes within the plurality of nodes that can be taken to a DOWN state in which the identified nodes cannot communicate with any others of the plurality of nodes; and determining at least one of the nodes stored in the candidate array to be taken to a DOWN state.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 is a block diagram of a multiple of computers connected in a cluster that is in a symmetrical condition according to one or more embodiments of the present invention;

FIG. 4 is a block diagram of the multiple of computers of FIG. 3 connected in a cluster that is in an asymmetrical condition according to one or more embodiments of the present invention; and

FIG. 5 is a flow diagram of a method for reconciling an asymmetric topology condition in a cluster of computers in accordance with one or more embodiments of the present invention.

### DETAILED DESCRIPTION

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

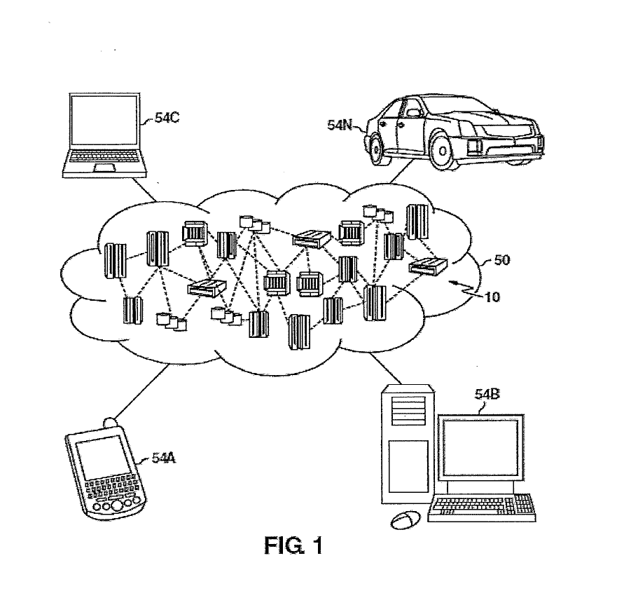

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

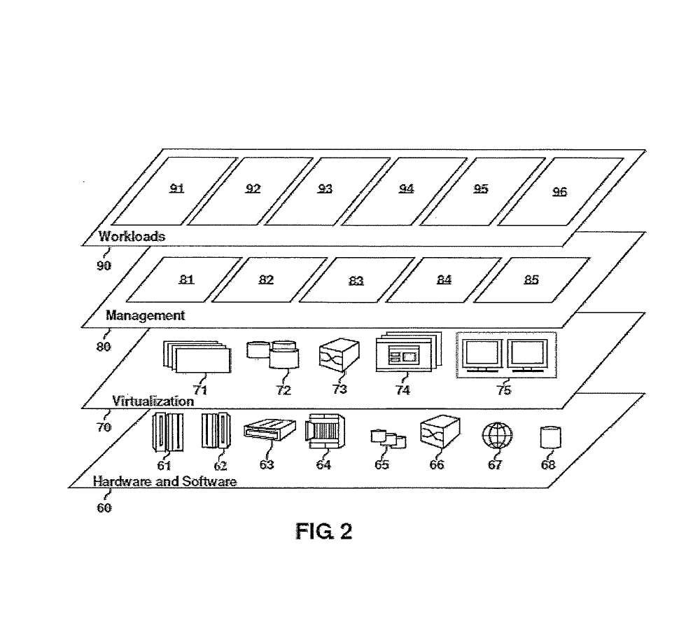

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and a method 96 for reconciling an asymmetric topology condition in a cluster of computers in accordance with one or more embodiments of the present invention.

In accordance with one or more embodiments of the present invention, methods, systems, and computer program products are disclosed for reconciling an asymmetric topology condition in a cluster of computers.

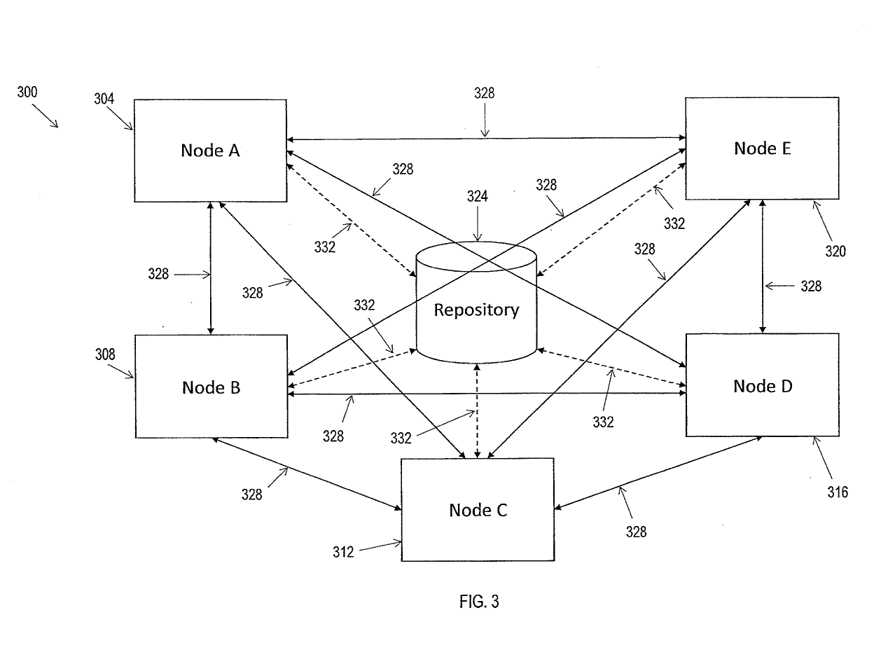

Referring to FIG. 3, there illustrated is a block diagram of a multiple or plurality of computers or nodes (Node A-Node E) 304-320 connected in a cluster configuration or topology 300 that is in a symmetrical condition, according to one or more embodiments of the present invention. Although not shown, each of the computers 304-320 may comprise known components, such as, for example, a processor or processing unit, a memory, a monitor, a keyboard, a mouse, etc. Each of the computers 304-320 may reside or be a part of the cloud computing environment 50 described hereinabove and illustrated in FIGS. 1 and 2, or may comprise some other type of computer environment.

Also illustrated in FIG. 3 is a centralized data storage device or repository 324 that may be shared among each of the computers 304-320 in the cluster 300. The repository 324 may be used to store data and/or information of various types for access by each of the computers or nodes 304-320. The repository 324 is not required in the broadest scope of embodiments of the present invention. Also, more or less than five computers or nodes 304-320 may be connected in a cluster configuration in other embodiments of the present invention. In the discussion herein, it is to be understood that the five computers 304-320 within the cluster configuration 300 shown in FIG. 3 merely represents an exemplary embodiment.

All five of the computers (Node A-Node E) 304-320 and the repository 324 shown in FIG. 3 may be connected together in a symmetrical configuration or topology. In an exemplary embodiment, the computers 304-320 may be connected to each other by way of network connections or interfaces, as shown in FIG. 3 by the solid lines 328. Also in this exemplary embodiment, each of the computers 304-320 may be connected to the repository by way of a DISK connection or interface, as shown in FIG. 3 by the dashed lines 332. As mentioned above, other types of connection mediums, protocols or interfaces may be utilized in light of the teachings herein. These include, for example, Ethernet, TCP/IP, TCP, a storage area network (SAN), a local area network (LAN), a wide area network (WAN), a data information service center (DISK.), or a direct connection.

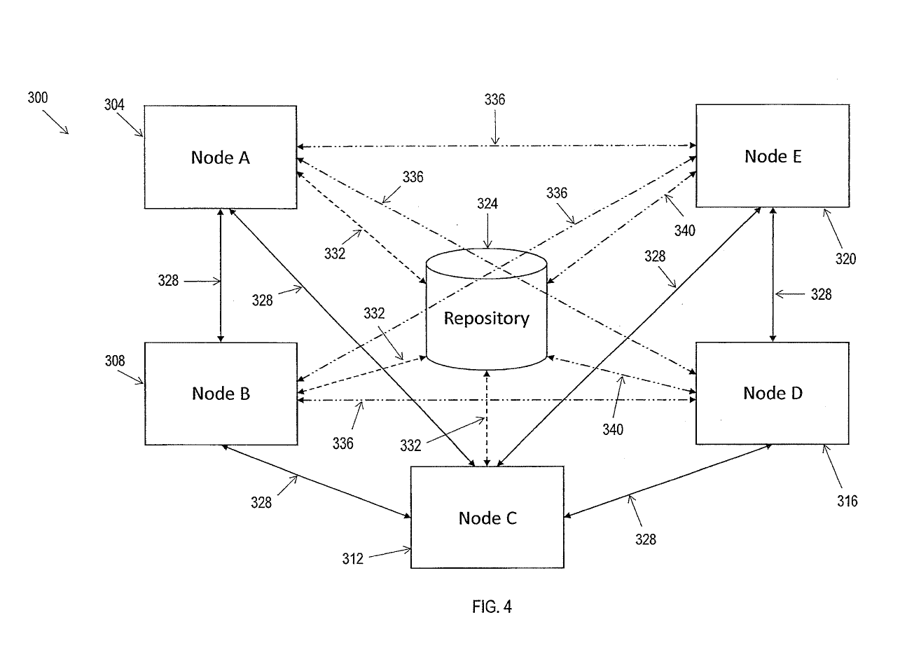

Referring now to FIG. 4, there illustrated is a block diagram of the multiple or plurality of computers 304-320 and the repository 324 of FIG. 3 connected in a cluster configuration or topology that is in an asymmetrical condition according to one or more embodiments of the present invention. It should be noted that FIG. 4 and the corresponding discussion herein represents just one example of an asymmetric condition of a cluster configuration 300 of a plurality of computers 304-312 and a repository 324. Other asymmetric conditions are possible.

In the embodiment shown in FIG. 4, the Node A computer 304 is illustrated as having lost its network connection (the solid line 328 in FIG. 3) to each of Node D 316 and Node E 320. This is shown in FIG. 4 by the solid line 328 of FIG. 3 being replaced in each instance of a lost network connection by a line 336 having alternating two dots and a dash. Node A 304 retains its connections to Node B 308, Node C 312, and the repository 324.

Similarly, as seen in FIG. 4, in this exemplary embodiment Node B 308 has lost its network connection to each of Node D 316 and Node E 320, again as illustrated by the lines 336 having alternating two dots and a dash. Also, in this exemplary embodiment, each of Node D 316 and Node E 320 has lost its DISK connection to the repository 324. This is illustrated in FIG. 4 by the dashed lines 332 of FIG. 3 being replaced by the lines 340 having alternating two dots and a dash.

The result in FIG. 4 is that the cluster connection 300 of the computers 304-320 and the repository 324 is now in an asymmetric configuration or topology (AST). More specifically, Node A 304, Node B 308 and Node C 312 have formed one island, while Node C 312, Node D 316 and Node E 320 have formed another island. As such, neither Node A 304 nor Node B 308 can “gossip” or exchange heartbeat signals with Node D 316 and Node E 320. Also, Node C 312 is connected with or can gossip with every other node—i.e., Node A 304, Node B 308, Node D 316 and Node E 320.

Also, Node A 304 and Node B 308 each mark or consider Node D 316 and Node E 320 as being in a “DOWN” state or condition. Also, from the perspective of Node A 304 and Node B 308, each of Node A 304, Node B 308 and Node C 312 are marked or considered as being in an “UP” state or condition. Similar situations may be seen from the perspectives of Node D 316 and Node E 320.

Such loss of symmetry within the cluster configuration 300 can create cluster operability issues. For example, cluster-wide locks or node leadership may be erroneously granted, leading to corruption of the repository 324 or a database shared amongst the nodes. For instance, if Node A 304 wants to acquire a lock it would contact only Node B 308 and Node C 312, since Node A 304 can only gossip with Node B 308 and Node C 312. If Node B 308 or Node C 312 is not using the lock, then Node A 304 would be granted the lock. Further, if Node D 316 now needs to acquire a cluster-wide lock, it would contact Node C 312 and Node E 320, and if either of these nodes is not using the lock, then the lock would be granted to Node D 316. As a result both A and D have locks at the same time. This will lead to corruption. This would also create confusion among the upper layers of the computer network. If Node D 316 is running some workload, and as soon as Node A 304 detects that Node D 316 is DOWN, then Node A 304 may take over the workload. Now, both Node A 304 and Node D 316 are running the same workload, thereby accessing the same resources which can again lead to corruption.

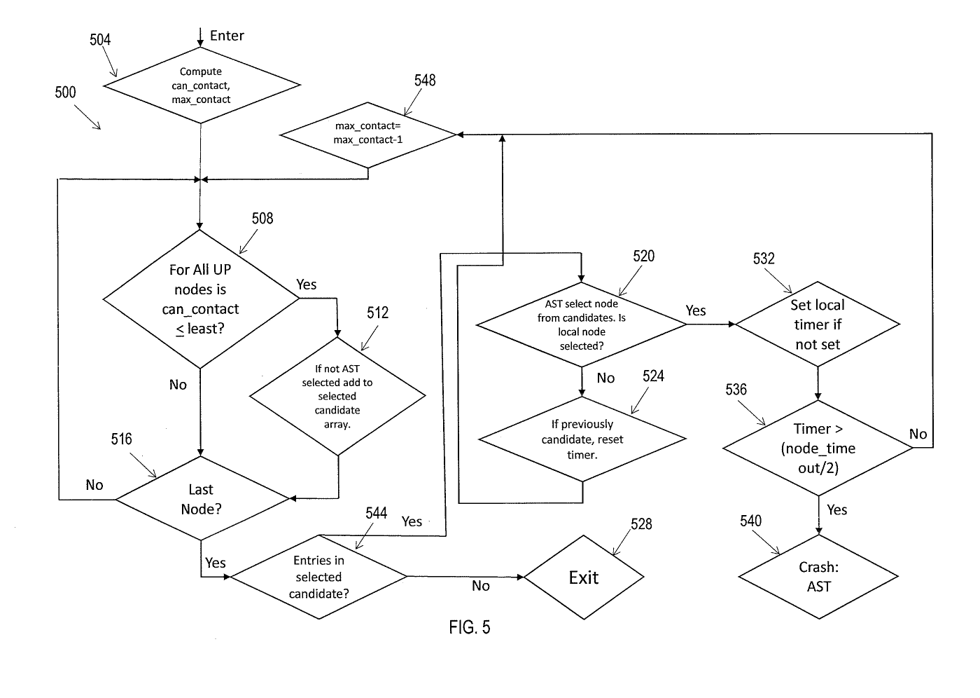

With reference now to FIG. 5, a flow diagram illustrates a method 500 according to one or more embodiments of the present invention for reconciling relatively quickly an asymmetric topology condition in a cluster 300 of computers 304-320. The method 500 of embodiments of the present invention works to re-stabilize the asymmetric computer cluster configuration or topology of FIG. 4 as quickly as possible back into a symmetric configuration or topology, and with the least amount of the computers or nodes 304-320 being considered to be in the DOWN state or condition (in other words, with the most amount of the computers or nodes 304-320 being in the UP state or condition).

In one or more embodiments of the present invention, the method 500 may be embodied in software that is executed by computer elements located within a network that may reside in the cloud, such as the cloud computing environment 50 described hereinabove and illustrated in FIGS. 1 and 2.

More specifically, the method 500 of FIG. 5 may be implemented and operated recursively and simultaneously on each of the computers or nodes 304-320 of FIGS. 3 and 4. This is done to ensure that all of the nodes 304-320 that are affected by the asymmetric cluster configuration (AST) are set to the DOWN state or condition relatively quickly, for example within a node_timeout interval of, e.g., 30 seconds. What is left within the cluster configuration 300 after selected DOWN nodes are taken down or “crashed” is a symmetric topology comprising the remaining computers or nodes 304-320 that are in the UP state or condition. Thus, a consistent view among the remaining UP nodes 304-320 is provided across the topology or cluster configuration 300, thereby avoiding problems within the cluster configuration such as the granting of a lock to more than one computer or node 304-320, as discussed hereinabove.

In embodiments of the present invention, each computer or node 304-320 within the cluster configuration 300 runs the computer-implemented method 500 of the flow diagram of FIG. 5. Each computer or node 304-320 may be “triggered” or prompted to run the method 500 only when an asymmetric condition or “problem” is detected or is in existence within the cluster configuration 300. In the alternative, each node 304-320 may run the method 500 all the time, or may run the method 500 upon the occurrence of a certain event.

After entering the method 500 of FIG. 5, an operation in block 504 comprises the computer or node determining or calculating its can_contact variable information that is specific to the particular node. That is, Node A 304 determines its can_contact variable, Node B 308 determines its can_contact variable, Node C 312 etc., all through each of the nodes 304-320 within the cluster configuration 300. That is, if the cluster contains, for example, 100 computers or nodes, each of the 100 computers or nodes determines its can_contact variable information.

In embodiments of the present invention, the can_contact variable may comprise two values: a first “Own” value (e.g., local_can_contact), and a second “Max” value (e.g., max_can_contact or max_contact). The operation in block 504 may also determine a Least value, as discussed in more detail hereinafter. The Own value comprises the number of other nodes 304-320 in the cluster configuration 300 that the particular node can gossip or communicate with at that particular time. For example, in the example given above with respect to the asymmetric configuration of FIG. 4, Node A 304 is able to gossip only with Node B 308 and Node C 312, since Node A 304 has lost its connection with Node D 316 and Node E 320. Thus, the Own value for Node A equals 2 in this example (i.e., the two nodes Node B 308 and Node C 312). Node A 304 sends this value in the gossips to the other nodes for their use in running the method 500. That is, even though Node A 304 may only be able to gossip directly with Node B 308 and Node C 312, the determined Own value for Node A 304 may still be able to make its way within the cluster 300 to all other nodes via Node C 312 gossips.

If a node 304-320 cannot communicate with another node for an interval of node_time_out/2 seconds, it would not forward that node's stale contact number to other nodes in the cluster 300. In this example, Node A 304 and Node B 308 will not forward the stale contact number of Node D 316 and Node E 320 to other nodes and vice versa. Node D 316 and Node E 320 will not forward the stale contact numbers of Node A 304 and Node B 308. This stale contact number is internally depicted by a very large positive number. Stale contact numbers are ignored and not updated in each node's local table which holds the contact numbers for all the nodes 304-320 in the cluster 300. Thus Node A 304 and Node B 308 will use the contact numbers of Node E 320 and Node D 316 as stated by Node C 312 and vice versa. This leads to relatively better control while running the method for determining the least contact value.

The Max value is the highest integer value of can_contact reported by any node 304-320. In this example, Node A 304 reports 2, Node B 308 reports 2, Node C 312 reports 4, Node D 316 reports 2, and Node E 320 reports 2, resulting in a value of Max of 4 amongst all reporting nodes. The value of Least is 2.

Another manifestation is if Node C 312 has lost access only to Node E 320. This means that Node C 312 only sees Node A 304, Node B 308, and Node D 316, which leads to a value of Max of 3. Thus, the value of Max is dependent upon the nature of the connections between the nodes 304-320 in the cluster 300.

In embodiments, the determination of values for both Own and Max may be carried out only during the first time running (i.e., iteration) of the method 500. Then, on successive recursive runs or iterations of the method 500 by any node, the operation in block 504 does not need to determine the values for both Own and Max, and instead may skip these determinations and determine a value only for the variable Max, which may be determined simply as the value for Max (i.e., max_can_contact) minus 1 as shown in the operation in block 548. In this example, the updated or new value for Max is 4−1=3, while the value for Least remains the same at 2. The iteration stops when Max is equal to Least.

An operation in block 508 then determines for each of the UP nodes 304-320 if the Own or can_contact value determined for that node is less than or equal to the determined value for Least. An “UP” node is any of the nodes 304-320 that has yet to be taken to a DOWN state or condition. Thus, for Node A 304, its determined Own or can_contact value is 2, which is less than Max=3 and equal to Least=2. Thus, the method 500 branches to operation in block 512 in which Node A 304 is added to the array of the selected candidate node(s) to be taken to the DOWN state. Also, in this operation in block 512, the value for Least is re-determined to be the can_contact value for the node (e.g., Node A 304) that was just added to the selected candidate array. Here, the value for Least is 2.

The method 500 then branches to operation in block 516 to check if the last node 304-320 (i.e., Node E 320) has been operated on by the method 500. If not, the method 500 then branches back to the operation in block 508 and iterates through the nodes 304-320 until the last node, Node E 320, has been considered.

For example, for Node B 308, its Own can_contact value is 2, which is equal to the current value of Least (i.e., as set in the operation in block 512 when Node A 304 was iterated). Thus, Node B 308 is added to the selected candidate array to be taken to the DOWN state. Continuing on, Node C 312 is not a candidate to be taken DOWN, while Node D 316 and Node E 320 are candidates to be taken DOWN. Thus, the selected candidate node(s) array determined from iterations of the operation in block 512 comprises Node A 304, Node B 308, Node D 316 and Node E 320, which are all of the nodes with the lowest count or contact value.

Once the last node (here, Node E 320) has been determined in the operation in block 516 to have been considered, an operation in block 544 if there are any entries in the selected candidate array. If not, the method 500 exits in an operation in block 528. If so, the method 500 branches to an operation in block 520 which determines whether or not the “local node” is a candidate to be taken to the DOWN state. Here, our discussion is focused on Node A 304, which is the local node. However, even though in this iteration it was determined as discussed hereinabove that Node A 304 was a candidate to be taken DOWN, assume that Node A 304 is not a candidate to be taken DOWN in a subsequent iteration. If so, then an operation in block 524 determines if Node A 304 was previously determined by the method 500 to be a selected candidate to be taken DOWN, then a local timer for Node A 304 is reset to zero in the operation in block 524. The method 500 then branches back to the operation in block 548.

However, since Node A 304 was previously determined to be a candidate node to be taken DOWN (along with Node B 308, Node D 316 and Node E 320), then in the operation in block 520, a tie breaker rule or policy is implemented which selects in this example from one of the four selected nodes (Node A 304, Node B 308, Node D 316 and Node E 320). Such tie breaker rule could be the priority of the Node. Assume Node A 304 is selected by the tie breaker rule. Then, in operation in block 532, a local timer is set if it has not already been set. Next, an operation in block 536 checks if the value of the local timer is greater than the node_timeout value divided by two. A typical value for the variable node_timeout is 30 seconds. Thus, if the value of the local timer is greater than 15 seconds, then Node A 304 is taken DOWN or made to crash in an operation in block 540. Instead, if the value of the local timer is not greater than 15 seconds, then the method 500 branches back to the operation in block 548.

Now consider Node B 308 iterations of the method 500. As discussed hereinabove with respect to Node A 304, the first iteration of the method 500 operating on Node B 308 will generate a selected candidate array consisting of Node A 304, Node B 308, Node D 316 and Node E 320. When the operation in block 520 is encountered, the tie breaker rule or policy will select Node A 304. It will then re-determine the values starting at the operation in block 508, excluding Node A 304. In this second iteration, the selected candidate array will consist of Node B 308, Node D 316 and Node E 320. Following the operation in block 520, Node B 308 will move onto the operation in block 532 and proceed accordingly through the method 500.

As can be seen from the foregoing, if at least one of the nodes 304-320 is identified as a candidate to be brought DOWN, the method 500 of embodiments of the present invention iterates to find any additional nodes, such that all affected nodes can be brought down concurrently with a stipulated time period. The method 500 also defines how the contact values of nodes are exchanged. Nodes which are not able to receive communication from nodes do not forward stale contact values.

The result of the method 500 of embodiments of the present invention running on each computer or node within a cluster configuration of such computers is that the one or more nodes in the cluster with the lowest node contact or connectivity with respect to the other nodes can take itself to a DOWN state or condition (i.e., effectively remove itself from the cluster) in a relatively quick period of time. This avoids an asymmetric condition within the cluster, thereby avoiding the disadvantages associated with such a condition. It also leaves those nodes with the highest contact or connectivity within the cluster and in a symmetric configuration.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

As used herein, the articles “a” and “an” preceding an element or component are intended to be nonrestrictive regarding the number of instances (i.e., occurrences) of the element or component. Therefore, “a” or “an” should be read to include one or at least one, and the singular word form of the element or component also includes the plural unless the number is obviously meant to be singular.

As used herein, the terms “invention” or “present invention” are non-limiting terms and not intended to refer to any single aspect of the particular invention but encompass all possible aspects as described in the specification and the claims.

As used herein, the term “about” modifying the quantity of an ingredient, component, or reactant of the invention employed refers to variation in the numerical quantity that can occur, for example, through typical measuring and liquid handling procedures used for making concentrates or solutions. Furthermore, variation can occur from inadvertent error in measuring procedures, differences in the manufacture, source, or purity of the ingredients employed to make the compositions or carry out the methods, and the like. In one aspect, the term “about” means within 10% of the reported numerical value. In another aspect, the term “about” means within 5% of the reported numerical value. Yet, in another aspect, the term “about” means within 10, 9, 8, 7, 6, 5, 4, 3, 2, or 1% of the reported numerical value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
determining, by a processor located within a particular node among a plurality of nodes, a number of nodes other than the particular node from among the plurality of nodes that the particular node can communicate with at a particular point in time;
determining, by the processor located within the particular node, that a number of the nodes within the plurality of nodes that the particular node can communicate with at a particular point in time is less than a value of a variable;
storing, by the processor located within the particular node, in a candidate array the determined number of nodes within the plurality of nodes that the particular node can communicate with at a particular point in time which is less than the value of a variable, wherein the candidate array identifies those nodes within the plurality of nodes that can be taken to a DOWN state in which the identified nodes cannot communicate with any others of the plurality of nodes; and
determining, by the processor located within the candidate array, at least one of the nodes stored in the candidate array to be taken to a DOWN state.

2. The computer-implemented method of claim 1 further comprising communicating, by the processor located within the particular node, the number of nodes other than the particular node from among the plurality of nodes that the particular node can communicate with at a particular point in time.

3. The computer-implemented method of claim 1 further comprising determining, by the processor located within the particular node, a maximum number of the plurality of nodes that the particular node may communicate with.

4. The computer-implemented method of claim 1 wherein determining, by the processor located within the candidate array, at least one of the nodes stored in the candidate array to be taken to a DOWN state comprises determining at least one of the nodes stored in the candidate array to be taken to a DOWN state using a tie-breaking rule.

5. The computer-implemented method of claim 1 wherein the plurality of nodes comprises a plurality of computers.

6. The computer-implemented method of claim 1 wherein the plurality of nodes comprises a plurality of computers, each one of the computers having a processor for performing the steps of:
determining, by a processor located within a particular node among a plurality of nodes, a number of nodes other than the particular node from among the plurality of nodes that the particular node can communicate with at a particular point in time;
determining, by the processor located within the particular node, that a number of the nodes within the plurality of nodes that the particular node can communicate with at a particular point in time is less than a value of a variable;
storing, by the processor located within the particular node, in a candidate array the determined number of nodes within the plurality of nodes that the particular node can communicate with at a particular point in time which is less than the value of a variable, wherein the candidate array identifies those nodes within the plurality of nodes that can be taken to a DOWN state in which the identified nodes cannot communicate with any others of the plurality of nodes; and
determining, by the processor located within the candidate array, at least one of the nodes stored in the candidate array to be taken to a DOWN state.

7. The computer-implemented method of claim 1 wherein determining, by the processor located within the candidate array, at least one of the nodes stored in the candidate array to be taken to a DOWN state comprises determining, by the processor located within the candidate array, at least one of the nodes stored in the candidate array to be taken to a DOWN state after a period of time.

8. A system comprising:
a processor in communication with one or more types of memory, the processor configured to:
determine a number of nodes other than a particular node from among a plurality of nodes that the particular node can communicate with at a particular point in time;
determine that a number of the nodes within the plurality of nodes that the particular node can communicate with at a particular point in time is less than a value of a variable;
store in a candidate array the determined number of nodes within the plurality of nodes that the particular node can communicate with at a particular point in time which is less than the value of a variable, wherein the candidate array identifies those nodes within the plurality of nodes that can be taken to a DOWN state in which the identified nodes cannot communicate with any others of the plurality of nodes; and
determine at least one of the nodes stored in the candidate array to be taken to a DOWN state.

9. The system of claim 8 wherein the processor is further configured to communicate the number of nodes other than the particular node from among the plurality of nodes that the particular node can communicate with at a particular point in time.

10. The system of claim 8 wherein the processor is further configured to determine a maximum number of the plurality of nodes that the particular node may communicate with.

11. The system of claim 8 wherein the processor configured to determine at least one of the nodes stored in the candidate array to be taken to a DOWN state comprises the processor configured to utilize a tie-breaking rule.

12. The system of claim 8 wherein the plurality of nodes comprises a plurality of computers.

13. The system of claim 8 wherein the plurality of nodes comprises a plurality of computers, each one of the computer having a processor configured to:
determine a number of nodes other than the particular node from among the plurality of nodes that the particular node can communicate with at a particular point in time;
determine that a number of the nodes within the plurality of nodes that the particular node can communicate with at a particular point in time is less than a value of a variable;
store in a candidate array the determined number of nodes within the plurality of nodes that the particular node can communicate with at a particular point in time which is less than the value of a variable, wherein the candidate array identifies those nodes within the plurality of nodes that can be taken to a DOWN state in which the identified nodes cannot communicate with any others of the plurality of nodes; and
determine at least one of the nodes stored in the candidate array to be taken to a DOWN state.

14. The system of claim 8 wherein the processor configured to determine at least one of the nodes stored in the candidate array to be taken to a DOWN state comprises the processor configured to determine at least one of the nodes stored in the candidate array to be taken to a DOWN state after a period of time.

15. A computer program product comprising:
a non-transitory storage medium readable by a processing circuit and storing instructions for execution by the processing circuit for performing a method comprising:
determining a number of nodes other than a particular node from among a plurality of nodes that the particular node can communicate with at a particular point in time;
determining that a number of the nodes within the plurality of nodes that the particular node can communicate with at a particular point in time is less than a value of a variable;
storing in a candidate array the determined number of nodes within the plurality of nodes that the particular node can communicate with at a particular point in time which is less than the value of a variable, wherein the candidate array identifies those nodes within the plurality of nodes that can be taken to a DOWN state in which the identified nodes cannot communicate with any others of the plurality of nodes; and
determining at least one of the nodes stored in the candidate array to be taken to a DOWN state.

16. The computer program product of claim 15 further comprising communicating the number of nodes other than the particular node from among the plurality of nodes that the particular node can communicate with at a particular point in time.

17. The computer program product of claim 15 further comprising determining a maximum number of the plurality of nodes that the particular node may communicate with.

18. The computer program product of claim 15 wherein determining at least one of the nodes stored in the candidate array to be taken to a DOWN state comprises determining at least one of the nodes stored in the candidate array to be taken to a DOWN state using a tie-breaking rule.

19. The computer program product of claim 15 wherein the plurality of nodes comprises a plurality of computers.

20. The computer program product of claim 15 wherein the plurality of nodes comprises a plurality of computers, each one of the computers having a processing circuit for performing the steps of:
determining a number of nodes other than the particular node from among the plurality of nodes that the particular node can communicate with at a particular point in time;
determining that a number of the nodes within the plurality of nodes that the particular node can communicate with at a particular point in time is less than a value of a variable;
storing in a candidate array the determined number of nodes within the plurality of nodes that the particular node can communicate with at a particular point in time which is less than the value of a variable, wherein the candidate array identifies those nodes within the plurality of nodes that can be taken to a DOWN state in which the identified nodes cannot communicate with any others of the plurality of nodes; and
determining at least one of the nodes stored in the candidate array to be taken to a DOWN state.
